(19) United States
(12) Patent Application Publication
(10) Pub. No.: US 2024/0372824 A1
(43) Pub. Date: Nov. 7, 2024

(54) EMAIL PROCESSING DEVICE AND METHOD

(71) Applicant: Quanta Computer Inc., Taoyuan City (TW)

(72) Inventors: Chi-Chang CHEN, Taoyuan City (TW); Chia-Hung LIN, Taoyuan City (TW); Chi-Kin KWOK, Taoyuan City (TW); Chih-Wei LEE, Taoyuan City (TW); Hung-Pin CHU, Taoyuan City (TW)

(21) Appl. No.: 18/471,481

(22) Filed: Sep. 21, 2023

(30) Foreign Application Priority Data
May 3, 2023 (TW) 112116383

(51) Int. Cl. H04L 51/212; H04L 9/40

(52) U.S. Cl. CPC H04L 51/212; H04L 63/1483

(57) ABSTRACT

An email processing device includes a link retrieval module, a link verification module and a link testing module. The link retrieval module receives an email and retrieves a link corresponding to the email. The link verification module receives the link, and outputs the link or generates a forwarding link according to the linkage state of the link. The link testing module receives the link, and perform a protective mechanism test on the link to generate a test result corresponding to the email. The link retrieval module receives the forwarding link, and retrieves the link corresponding to the forwarding link.

### CROSS REFERENCE TO RELATED APPLICATIONS

This application claims priority of Taiwan Patent Application No. 112116383, filed on May 3, 2023, the entirety of which is incorporated by reference herein.

### BACKGROUND OF THE INVENTION

### Field of the Invention

The present invention relates to a processing device and method, and in particular it relates to an email processing device and method.

### Description of the Related Art

In general, phishing is used for social engineering attacks, and phishing emails are sent to the target of the attack to lure him into clicking a malicious link or opening a malicious file. Although companies use various email protection systems to protect their employees by filtering out such phishing emails, attackers may still formulate methods to circumvent these email protection mechanisms, which fools users into thinking that the email has been cleared as safe by the protection mechanism, increasing the user's trust and increasing the chances of a successful attack. Therefore, it may increase the risk of being lured or attacked by phishing letters, which causes inconvenience of use. Therefore, how to effectively protect email has become a focus for technical improvements by various manufacturers.

### BRIEF SUMMARY OF THE INVENTION

An embodiment of the present invention provides an email processing device and method, thereby reducing the risk of being lured or attacked by phishing letters, and increasing the convenience of use.

An embodiment of the present invention provides an email processing device, which includes a link retrieval module, a link verification module and a link testing module. The link retrieval module is configured to receive an email and retrieve a link corresponding to the email. The link verification module is configured to receive the link, and output the link or generate a forwarding link according to the linkage state of the link. The link testing module is configured to receive the link, and perform a protective mechanism test on the link to generate a test result corresponding to the email. The link retrieval module receives the forwarding link, and retrieves the link corresponding to the forwarding link.

An embodiment of the present invention provides an email processing method, which includes the following steps. A link retrieval module is used to receive an email and retrieve a link corresponding to the email. A link verification module is used to receive the link, and output the link or generate a forwarding link according to the linkage state of the link. A link testing module is used to receive the link, and perform a protective mechanism test on the link to generate a test result corresponding to the email. The link retrieval module is used to receive the forwarding link, and retrieve the link corresponding to the forwarding link.

According to the email processing device and method disclosed by the present invention, the link retrieval module retrieves the link corresponding to the email, the link verification module outputs the link or generates the forwarding link according to the linkage state of the link, the link testing module performs the protective mechanism test on the link to generate the test result corresponding to the email, and the link retrieval module receives the forwarding link, and retrieves the link corresponding to the forwarding link. Therefore, it may effectively reduce the risk of being lured or attacked by phishing letters, increase the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of an email processing device according an embodiment of the present invention;

FIG. 2 is a flowchart of an email processing method according an embodiment of the present invention;

FIG. 3 is a detailed flowchart of step S204 in FIG. 2;

FIG. 4 is a detailed flowchart of step S206 in FIG. 2; and

FIG. 5 is a flowchart of an email processing method according another embodiment of the present invention.

### DETAILED DESCRIPTION OF THE INVENTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents an element or component that is the same or similar.

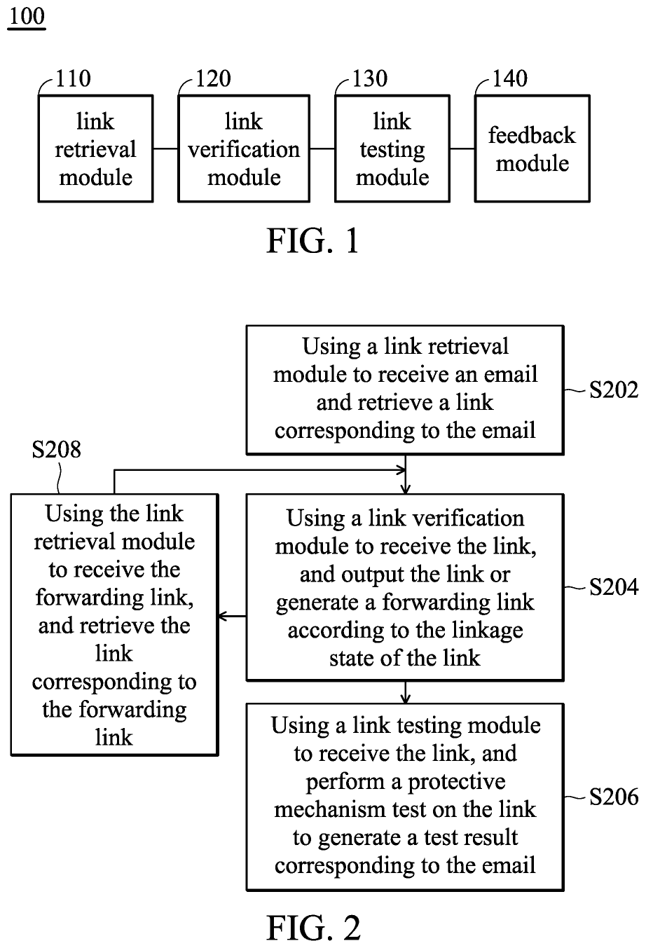

FIG. 1 is a schematic view of an email processing device according an embodiment of the present invention. In the embodiment, the email processing device 100 may be an electronic product, such as a personal computer, a notebook computer or a smart phone, but the present invention is not limited thereto. Please refer to FIG. 1. The email processing device 100 includes a link retrieval module 110, a link verification module 120 and a link testing module 130.

The link retrieval module 110 may receive an email and retrieves a link corresponding to the email. That is, when the link retrieval module 110 receive the email, the link retrieval module 110 may retrieve the link in the email, so as to receive the link corresponding to the email from the email. In the embodiment, the link retrieval module 110 may detect a keyword in the email, so as to determine the link in the email through the keyword, and retrieve the link in the email. In some embodiments, the link corresponding to the email may be a hyper link, but the present invention is not limited thereto.

The link verification module 120 may be coupled to the link retrieval module 110. The link verification module 120 may receive the link retrieved by the link retrieval module 110, and output the link or generate a forwarding link according to the linkage state of the link.

Furthermore, when the link verification module 120 receives the link retrieved by the link retrieval module 110, the link verification module 120 may determine whether the linkage state has a forwarding function. When determining that the above linkage state has a forwarding function, it indicates that this link may be forwarded and converted into another link. Then, the link verification module 120 may perform the forwarding function on the link to generate the corresponding forwarded forwarding link. When determining that the linkage state does not have the forwarding function, it indicates that this link may not be forwarded and this link is linked to a webpage. Then, the verification module 120 outputs the link.

In addition, after the verification module 120 generate the forwarding link, the verification module 120 may transmit the forwarding link to the link retrieval module 110. Then, the link retrieval module 110 may receive the forwarding link output by the link verification module 120, and retrieve the link corresponding to the forwarding link. That is, when the link retrieval module 110 receives the forwarding link, it indicates that the email has been forwarded at least once, and the link retrieval module 110 may receive the link in the forwarding link, so as to retrieve the link corresponding to the forwarding link from the forwarding link.

Afterward, the link retrieval module 110 may transmit the retrieved link corresponding link to the link verification module 120. Then, the link verification module 120 may determine again whether the linkage state of the above link has the forwarding function. If the link verification module 120 determines that the linkage state of the link still has the forwarding function, then the link verification module 120 may generate the forwarding link again, and transmit the forwarding link to the link retrieval module 110 to retrieve the link, until the link verification module 120 determines that the linkage state of the above link does not have the forwarding function (i.e., the linkage state of the above link is linked to a webpage).

That is, through the mutual operation of the link retrieval module 110 and the link verification module 120, until the link verification module 120 determines the linkage state of the last link of the email does not have the forwarding function (i.e., the last link is lined to a webpage), the entire forwarding process of email is completed, and then the email processing device 100 may perform the subsequent process on the last link of email. Therefore, it may effectively reduce the risk that a certain forwarding link in the email is determined as security by the protective tool, and finally links to a detected malicious link. In some embodiments, the link corresponding to the forwarding link may also be a hyper link, but the present invention is not limited thereto.

The link testing module 130 may be coupled to the link verification module 120. The link testing module 130 may receive the link output by the link verification module 120, and perform a protective mechanism test on the link to generate a test result corresponding to the email.

Furthermore, when the link testing module 130 obtain the link output by the link verification module 120, the link testing module 130 may compare the network address of the link with the predetermined network address, so as to generate the test result. In some embodiments, the predetermined network address may be stored in a database of the link testing module 130. In addition, the above predetermined network address is, for example, a network address with a risk state, and the predetermined network address may be pre-stored in the database of the link testing module 130.

In the embodiment, when the link testing module 130 obtains the link output by the link verification module 120, the link testing module 130 may retrieve the network address of the link, so as to obtain the network address of the link. In addition, the link testing module 130 may obtain the predetermined network address from the database. Then, the link testing module 130 may compare the network address with the predetermined network address to determine whether the network address matches the predetermined network address, and then generate the corresponding test result.

For example, when the link testing module 130 determines that the network address matches the predetermined network address, the link testing module 130 may generate the test result that “the network address matches with the predetermined network address”. When the link testing module 130 determines that the network address does not match the predetermined network address, the link testing module 130 may generate the test result that “the network address does not match the predetermined network address”.

In addition, when the above link further includes a downloading file, in addition to comparing the network address with the predetermined network address, the link testing module 130 may further perform a risk test of the protective mechanism test on the downloading file to generate the test result. In the embodiment, the risk test is, for example, a sandbox test, but the present invention is not limited thereto. Therefore, the security of determining the email may be increased.

In the embodiment, the email processing device 100 may further include a feedback module 140. The feedback module 140 may be coupled to the link testing module 130. The feedback module 140 may receive the test result generated by the link testing module 130, and feed back the state of the email according to the test result.

In some embodiments, the state of the email may include a security state or a risk state. For example, when the feedback module 140 receives the test result that “the network address matches the predetermined network address” generated by the link testing module 130, it indicates that the link of the email is risky, and the feedback module 140 may feed back the state of the email as “risk state”. When the feedback module 140 receives the test result that “the network address does not match the predetermined network address” generated by the link testing module 130, it indicates that the state of the link is security, and the feedback module 140 may feed back the state of the email as “security state”.

In addition, when the state of the email is the risk state, the feedback module 140 may block the email. Therefore, it may effectively reduce the risk of being lured or attacked by phishing letters, increase the convenience of use, solve the evasion manner of fraudulent links with multiple covers, more accurately find out the risk of the link in the letter and remind the recipient, and notify and block the final risk address.

FIG. 2 is a flowchart of an email processing method according an embodiment of the present invention. In step S202, the method involves using a link retrieval module to receive an email and retrieve a link corresponding to the email. In step S204, the method involves using a link verification module to receive the link, and output the link or generate a forwarding link according to the linkage state of the link.

In step S206, the method involves using a link testing module to receive the link, and perform a protective mechanism test on the link to generate a test result corresponding to the email. In step S208, the method involves using the link retrieval module to receive the forwarding link, and retrieve the link corresponding to the forwarding link.

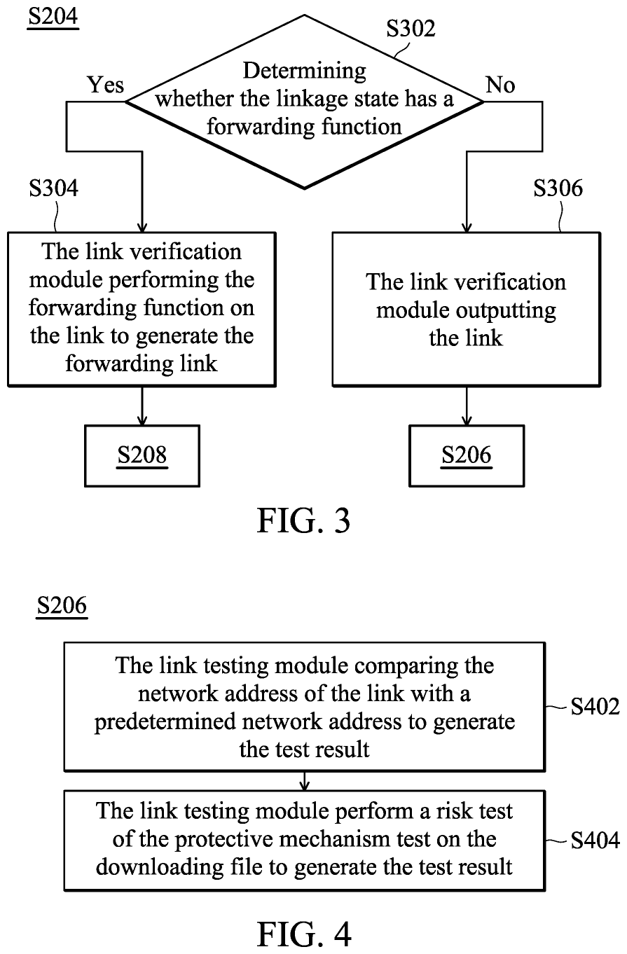

FIG. 3 is a detailed flowchart of step S204 in FIG. 2. In step S302, the method involves determining whether the linkage state has a forwarding function. When determining that the linkage state has the forwarding function, the method performs step S304. In step S304, the method involves the link verification module performing the forwarding function on the link to generate the forwarding link. After step S304 is performed, then the method may perform step S208 in FIG. 2. When determining that the linkage state does not have the forwarding function, the method performs step S306. In step S306, the method involves the link verification module outputting the link. After step S306 is performed, the method may perform step S206 in FIG. 2.

FIG. 4 is a detailed flowchart of step S206 in FIG. 2. In step S402, the method involves the link testing module comparing the network address of the link with a predetermined network address to generate the test result. In addition, when the above link includes a downloading file, step S404 may be included after step S402. In step S404, the method involves the link testing module perform a risk test of the protective mechanism test on the downloading file to generate the test result.

In the embodiment, step S404 is optional. That is, in some embodiments, when the above link includes the downloading file, the email processing method may perform step S404 after performing step S402. In some embodiments, when the above link does not include the downloading file, the email processing method may only perform step S402, but not perform step S404.

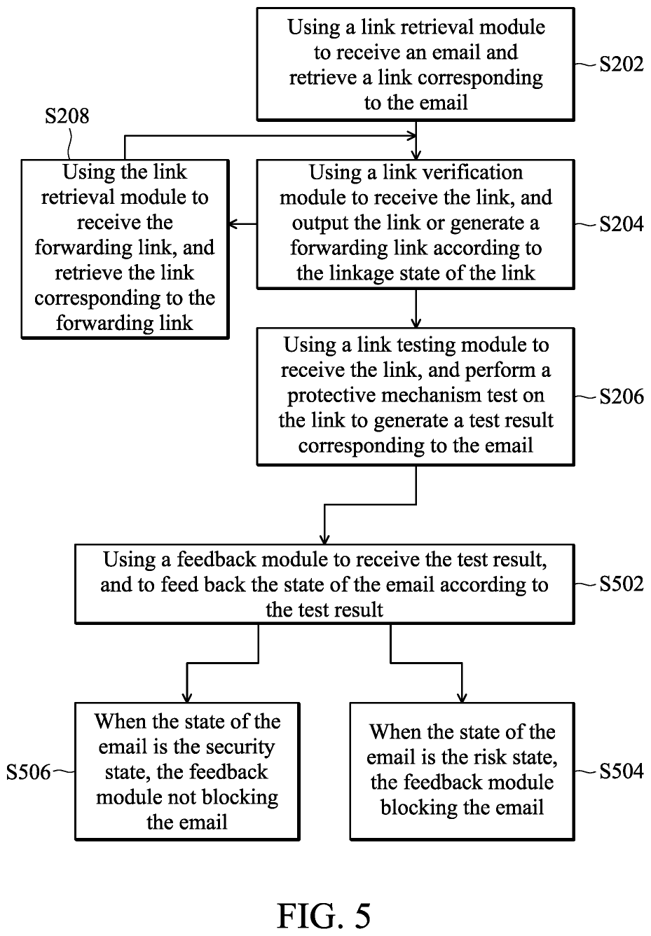

FIG. 5 is a flowchart of an email processing method according another embodiment of the present invention. In the embodiment, steps S202-S208 in FIG. 5 are the same as or similar to steps S202-S208 in FIG. 2. Accordingly, steps S202-S208 in FIG. 5 may refer to the description of the embodiment of FIG. 2, and the description thereof is not repeated herein.

In step S502, the method involves using a feedback module to receive the test result, and to feed back the state of the email according to the test result. In some embodiments, the state of the above email includes, for example, a security state or a risk state. In step 504, the method involves when the state of the email is the risk state, the feedback module blocking the email. In step S506, the method involves when the state of the email is the security state, the feedback module not blocking the email.

It should be noted that the order of the steps of FIG. 2, FIG. 3, FIG. 4 and FIG. 5 is only for illustrative purpose, but not intended to limit the order of the steps of the present invention. The user may change the order of the steps above according the requirement thereof. The flowcharts described above may add additional steps or use fewer steps without departing from the spirit and scope of the present invention.

In summary, according to the email processing device and method disclosed by the embodiment of the present invention, the link retrieval module retrieves the link corresponding to the email, the link verification module outputs the link or generates the forwarding link according to the linkage state of the link, the link testing module performs the protective mechanism test on the link to generate the test result corresponding to the email, and the link retrieval module receives the forwarding link, and retrieves the link corresponding to the forwarding link. Therefore, it may effectively reduce the risk of being lured or attacked by phishing letters, increase the convenience of use, and solve the evasion manner of fraudulent links with multiple covers.

In addition, the embodiment may further include the feedback module, the feedback module may feed back the state of the email according to the test result, and when the state of the email is the risk state, the feedback module may block the email. Therefore, it may more effectively find out the risk of the link in the letter and remind the recipient, and notify and block the final risk address.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

1. An email processing device, comprising:
a processor configured to implement a link retrieval module, a link verification module, and a link testing module, wherein:
the link retrieval module is configured to receive an email, detect a keyword in the email, determine a link in the email through the keyword, and retrieve the link corresponding to the email;
the link verification module is configured to receive the link, and output the link or generate a forwarding link according to a linkage state of the link; and
the link testing module is configured to receive the link, and perform a protective mechanism test on the link to generate a test result corresponding to the email;
wherein the link retrieval module receives the forwarding link, and retrieves the link corresponding to the forwarding link.

2. The email processing device as claimed in claim 1, wherein the link verification module determines whether the linkage state has a forwarding function, when determining that the linkage state has the forwarding function, the link verification module performs the forwarding function on the link to generate the forwarding link, and when determining that the linkage state does not have the forwarding function, the link verification module outputs the link.

3. The email processing device as claimed in claim 1, wherein the processor is further configured to implement
a feedback module, wherein the feedback module is configured to receive the test result, and feed back a state of the email according to the test result.

4. The email processing device as claimed in claim 3, wherein the state of the email comprises a security state or a risk state.

5. The email processing device as claimed in claim 4, wherein when the state of the email is the risk state, the feedback module blocks the email.

6. The email processing device as claimed in claim 1, wherein the link testing module compares a network address of the link with a predetermined network address to generate the test result.

7. The email processing device as claimed in claim 6, wherein the link comprises a downloading file, and the link testing module performs a risk test of the protective mechanism test on the downloading file to generate the test result.

8. An email processing method, comprising:
using a link retrieval module to receive an email, detect a keyword in the email, determine a link in the email through the keyword, and retrieve the link corresponding to the email;
using a link verification module to receive the link, and output the link or generate a forwarding link according to a linkage state of the link;
using a link testing module to receive the link, and perform a protective mechanism test on the link to generate a test result corresponding to the email; and
using the link retrieval module to receive the forwarding link, and retrieve the link corresponding to the forwarding link.

9. The email processing method as claimed in claim 8, wherein the step of outputting the link or generating the forwarding link according to the linkage state of the link comprises:
determining whether the linkage state has a forwarding function;
when determining that the linkage state has the forwarding function, the link verification module performing the forwarding function on the link to generate the forwarding link; and
when determining that the linkage state does not have the forwarding function, the link verification module outputting the link.

10. The email processing method as claimed in claim 8, further comprising:
using a feedback module to receive the test result, and to feed back a state of the email according to the test result.
